(19) United States
(12) Patent Application Publication
(10) Pub. No.: US 2024/0003383 A1
(43) Pub. Date: Jan. 4, 2024

(54) MULTI-ROW BEARING ASSEMBLY

(71) Applicant: SCHAEFFLER TECHNOLOGIES AG & CO. KG, Herzogenaurach (DE)

(72) Inventors: Rajmohan Kolli, Sterling Heights, MI (US); Zheng Wang, Rochester Hills, MI (US); Shakeel Shaikh, Windsor (CA); Victoria Poole, Livonia, MI (US)

(73) Assignee: SCHAEFFLER TECHNOLOGIES AG & CO. KG, Herzogenaurach (DE)

(21) Appl. No.: 17/854,878

(22) Filed: Jun. 30, 2022

(51) Int. Cl. F16C 19/18; F16C 33/58

(52) U.S. Cl. CPC F16C 19/181; F16C 33/585; F16C 2240/34; F16C 2240/70

(57) ABSTRACT

A bearing assembly is disclosed herein. The bearing assembly includes a first inner ring and a second inner ring, as well as an outer ring. A first plurality of rolling elements are arranged to be supported between the first inner ring and the outer ring. A second plurality of rolling elements are arranged to be supported between the second inner ring and the outer ring. A third plurality of rolling elements are arranged to be supported between the second inner ring and the outer ring. The second plurality of rolling elements is arranged axially between the first and third plurality of rolling elements. Various dimensions and aspects of the bearing assembly are designed in order to provide increased efficiency and a reduced envelope.

### FIELD OF INVENTION

The present disclosure relates to a multi-row bearing assembly.

### BACKGROUND

Multi-row bearing assemblies are well known. Multi-row bearing assemblies can be used in wheel bearing applications. In these particular applications, it is critical both provide a high efficiency and also provide a relatively smaller envelope or footprint.

It would be desirable to provide a multi-row bearing assembly that is both efficient and compact.

### SUMMARY

A bearing assembly is disclosed herein. The bearing assembly includes a first inner ring and a second inner ring, as well as an outer ring. A first plurality of rolling elements are arranged to be supported between the first inner ring and the outer ring. A second plurality of rolling elements are arranged to be supported between the second inner ring and the outer ring. A third plurality of rolling elements are arranged to be supported between the second inner ring and the outer ring. The second plurality of rolling elements is arranged axially between the first and third plurality of rolling elements.

A first contact angle (θ1) can be defined between the first plurality of rolling elements and the first inner ring and the outer ring, a second contact angle (θ2) can be defined between the second plurality of rolling elements and the second inner ring and the outer ring, and a third contact angle (θ3) can be defined between the third plurality of rolling elements and the second inner ring and the outer ring. The second contact angle (θ2) can be less than the first or third contact angles. The second contact angle (θ2) can be 20 degrees-40 degrees.

A first axial distance (A1) can be defined between the second and third plurality of rolling elements that is less than or equal to a second axial distance (A2) defined between the first and the second plurality of rolling elements.

The outer ring can define a first shoulder adjacent to the first plurality of rolling elements, and a second shoulder adjacent to the second plurality of rolling elements. The first shoulder and the second shoulder can be radially offset from each other.

A radial offset (R1) can be defined between the first shoulder and the second shoulder. The radial offset (R1) can be at least 4 mm.

The outer ring can define a first outer raceway for the first plurality of rolling elements and a second outer raceway for the second plurality of rolling elements. An axial offset (A3) can be defined between the first outer raceway and the second outer raceway, and the axial offset (A3) can be at least 4 mm.

A cage can be provided for supporting the second plurality of rolling elements, and another cage can be provided for supporting the third plurality of rolling elements. A distance (A4) can be defined between the two cages that is less than 0.5 mm.

An inner raceway for the second plurality of rolling elements can terminate radially inward from an inner raceway for the third plurality of rolling elements.

The outer ring can define a shoulder between an outer raceway for the second plurality of rolling elements and an outer raceway for the third plurality of rolling elements. The shoulder can be arranged radially outward from the outer raceway for the second plurality of rolling elements.

An outer diameter (OD1) of the outer ring on a first end of the outer ring that supports the first plurality of rolling elements can be equal to an outer diameter (OD2) of the outer ring on a second end of the outer ring that supports the third plurality of rolling elements.

The first plurality of rolling elements can have a larger diameter than a diameter of the second and third plurality of rolling elements.

Additional embodiments are disclosed herein.

### BRIEF DESCRIPTION OF THE DRAWINGS

The foregoing Summary and the following Detailed Description will be better understood when read in conjunction with the appended drawings, which illustrate a preferred embodiment of the disclosure. In the drawings:

FIG. 1 is a cross-sectional view of a bearing assembly.

FIG. 2 is a magnified view of a portion of FIG. 1 illustrating a first series of features.

FIG. 3 is a magnified view of a portion of FIG. 1 illustrating a second series of features.

FIG. 4 is a magnified view of a portion of FIG. 1 illustrating a third series of features.

FIG. 5 is a magnified view of a portion of FIG. 1 illustrating a fourth series of features.

FIG. 6 is a magnified view of a portion of FIG. 1 illustrating a fifth series of features.

FIG. 7 is a magnified view of a portion of FIG. 1 illustrating a sixth series of features.

FIG. 8 is a magnified view of a portion of FIG. 1 illustrating a seventh series of features.

FIG. 9 is a cross-sectional view of another aspect of the bearing assembly.

### DETAILED DESCRIPTION OF THE PREFERRED EMBODIMENTS

Certain terminology is used in the following description for convenience only and is not limiting. “Axially” refers to a direction along an axis (X) of an assembly. “Radially” refers to a direction inward and outward from the axis (X) of the assembly.

A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

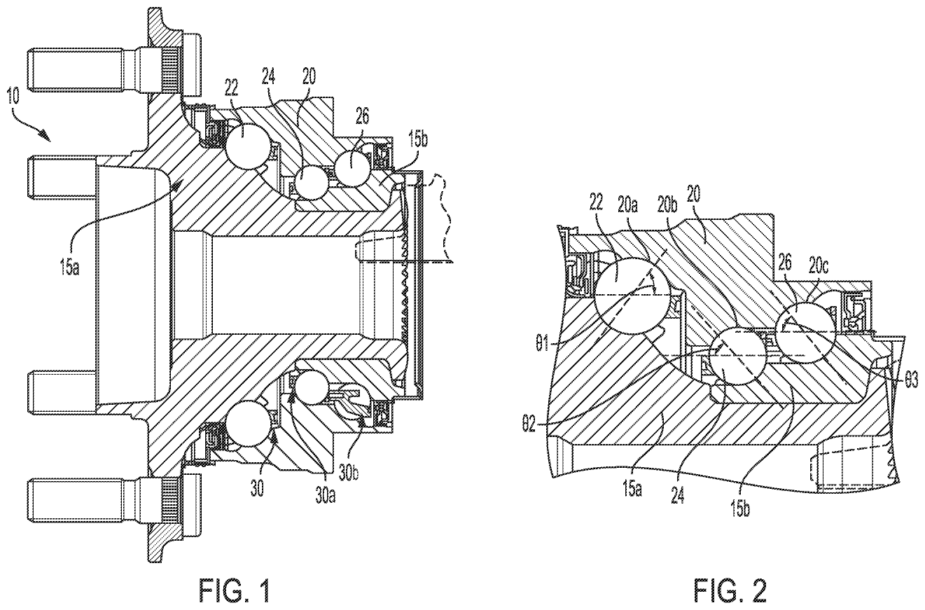

As shown in FIGS. 1-9, a bearing assembly 10 is disclosed herein. The bearing assembly includes at least one inner ring 15a, 15b and an outer ring 20. In one aspect, the inner ring can be formed as a unitary bearing ring, and in another aspect the inner ring can be formed as two separate bearing rings, i.e. a first inner ring 15a and a second inner ring 15b.

At least three rows of rolling elements can be provided. Specifically, a first plurality of rolling elements 22, a second plurality of rolling elements 24, and a third plurality of rolling elements 26 can be configured to be supported between the inner rings 15a, 15b and the outer ring 20. In one aspect, a diameter of the first plurality of rolling elements 22 can be larger than a diameter of the second and third plurality of rolling elements 24, 26.

The second plurality of rolling elements 24 can be arranged axially between the first and third plurality of rolling elements 22, 26. The second plurality of rolling elements 24 can have a smaller pitch diameter than the third plurality of rolling elements 26, and the third plurality of rolling elements 26 can have a smaller pitch diameter than the first plurality of rolling elements 22.

As shown in FIG. 2, a first contact angle (θ1) is defined between the first plurality of rolling elements 22 and the first inner ring 15a and the outer ring 20. A second contact angle (θ2) is defined between the second plurality of rolling elements 24 and the second inner ring 15b and the outer ring 20. A third contact angle (θ3) is defined between the third plurality of rolling elements 26 and the second inner ring 15b and the outer ring 20.

The second contact angle (θ2) can be less than the first contact angle (θ1) and less than the third contact angle (θ3). This configuration can promote improved friction performance, according to at least one advantage. In one aspect, the second contact angle (θ2) is 20 degrees-40 degrees. In one aspect, the first contact angle (θ1) is 30 degrees-45 degrees, and the third contact angle (θ3) is 30 degrees-45 degrees. One of ordinary skill in the art would understand that these values can vary.

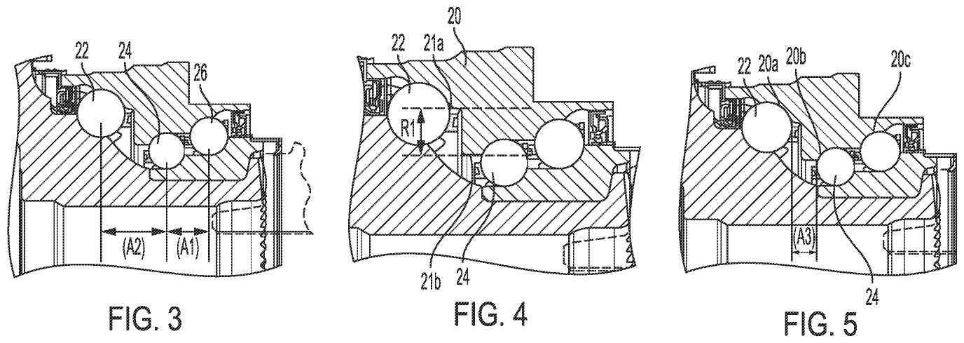

As shown in FIG. 3, a first axial distance (A1) can be defined between the second and third plurality of rolling elements 24, 26, and the first axial distance (A1) can be less than or equal to a second axial distance (A2) defined between the first and the second plurality of rolling elements 22, 24. The axial distances can be defined through a center line of each of the rolling elements. This configuration avoids heat treatment issues associated with the outer ring raceway due to a relatively larger second axial distance (A2) as compared to the first axial distance (A1).

As shown in FIG. 4, the outer ring 20 can define a first shoulder 21a adjacent to the first plurality of rolling elements 22, and the outer ring 20 can define a second shoulder 21b adjacent to the second plurality of rolling elements 24. The first and second shoulders 21a, 21b can be defined as flat cylindrical surfaces, in one aspect. The first shoulder 21a and the second shoulder 21b can be radially offset from each other. This offset allows for a greater quantity of rollers for the first plurality of rolling elements, which reduces fatigue and improves stiffness.

FIG. 4 illustrates an offset in a radial direction (R1) can be defined between the first shoulder 21a and the second shoulder 21b of the outer ring 20. In one aspect, this radial offset (R1) can be at least 4 mm. One of ordinary skill in the art would understand that this value can vary. This configuration promotes improved heat treatment for the outer ring by increasing a depth of the second shoulder 21b.

The outer ring 20 can define a first outer raceway 20a for the first plurality of rolling elements 22, a second outer raceway 20b for the second plurality of rolling elements 24, and a third outer raceway 20c for the third plurality of rolling elements 26. As shown in FIG. 5, an axial offset (A3) can be defined between the first outer raceway 20a and the second outer raceway 20b. In one aspect, this axial offset (A3) is at least 4 mm.

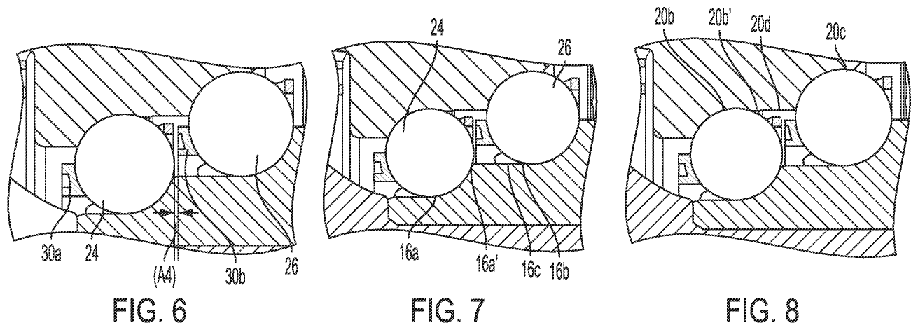

Referring to FIG. 6, a cage 30a can be provided for supporting the second plurality of rolling elements 24, and a cage 30b can also be provided for supporting the third plurality of rolling elements 26. A predetermined distance (A4) of less than 0.5 mm can be defined between the cage 30a supporting the second plurality of rolling elements 24 and the cage 30b supporting the third plurality of rolling elements 26. In one aspect, this configuration allows for larger rolling elements for the second and third plurality of rolling elements. A cage 30 can also be provided for the first plurality of rolling elements 22.

Referring to FIG. 7, the inner ring 15b can partially define a shoulder 16c between an inner raceway 16a for the second plurality of rolling elements 24 and an inner raceway 16b for the third plurality of rolling elements 26. As shown in FIG. 7, a terminal point 16a′ for the inner raceway 16a is positioned radially inward or radially offset relative to the inner raceway 16b for the third plurality of rolling elements 26. In one aspect, the terminal point 16a′ has a smaller diameter than (i.e. is positioned radially inward from) the inner raceway 16b for the third plurality of rolling elements 26. This configuration allows for the assembly of the bearing components.

Referring to FIG. 8, the outer ring 20 can define a shoulder 20d positioned between the outer raceway 20b for the second plurality of rolling elements 24 and the outer raceway 20c for the third plurality of rolling elements 26. The shoulder 20d can be arranged radially outward from the outer raceway 20b for the second plurality of rolling elements 24. A terminal point 20b′ for the outer raceway 20b of the second plurality of rolling elements 24 can be defined radially inward relative to the shoulder 20d. This configuration allows for assembly of the bearing components.

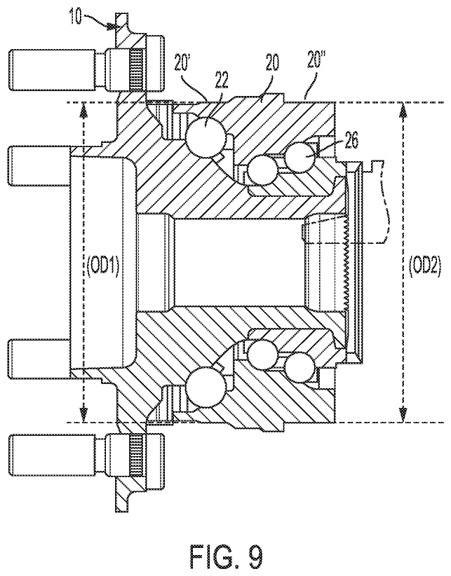

Referring to FIG. 9, an outer diameter (OD1) of the outer ring 20 on a first end 20′ of the outer ring 20 supporting the first plurality of rolling elements 22 can be equal to an outer diameter (OD2) of the outer ring 20 on an end 20″ of the outer ring 20 supporting the third plurality of rolling elements 26.

Having thus described the present disclosure in detail, it is to be appreciated and will be apparent to those skilled in the art that many physical changes, only a few of which are exemplified in the detailed description of the invention, could be made without altering the inventive concepts and principles embodied therein.

It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the embodiments being indicated by the appended claims rather than by the foregoing description, and all alternate embodiments and changes to this embodiment which come within the meaning and range of equivalency of said claims are therefore to be embraced therein.

### LOG OF REFERENCE NUMERALS

bearing assembly 10
first inner ring 15a
second inner ring 15b
inner raceway 16a for second plurality of rolling elements
terminal point 16a′ for the inner raceway
inner raceway 16b for third plurality of rolling elements
shoulder 16c of inner ring 15b
outer ring 20
outer raceway 20a for first plurality of rolling elements
outer raceway 20b for second plurality of rolling elements
terminal point 20b′ for the outer raceway of the second plurality of rolling elements
outer raceway 20c for third plurality of rolling elements
shoulder 20d of outer ring
shoulder 21a of outer ring
shoulder 21b of outer ring
first plurality of rolling elements 22
second plurality of rolling elements 24
third plurality of rolling elements 26
cage 30 for the first plurality of rolling elements
cage 30a for second plurality of rolling elements
cage 30b for third plurality of rolling elements

What is claimed is:

1. A bearing assembly comprising:
a first inner ring and a second inner ring;
an outer ring; and
a first plurality of rolling elements arranged to be supported between the first inner ring and the outer ring;
a second plurality of rolling elements arranged to be supported between the second inner ring and the outer ring; and
a third plurality of rolling elements arranged to be supported between the second inner ring and the outer ring, wherein the second plurality of rolling elements is arranged axially between the first and third plurality of rolling elements;
wherein a first contact angle (θ1) is defined between the first plurality of rolling elements and the first inner ring and the outer ring, a second contact angle (θ2) is defined between the second plurality of rolling elements and the second inner ring and the outer ring, and a third contact angle (θ3) is defined between the third plurality of rolling elements and the second inner ring and the outer ring, and the second contact angle (θ2) is less than the first or third contact angles.

2. The bearing assembly according to claim 1, wherein the second contact angle (θ2) is 20 degrees-40 degrees.

3. The bearing assembly according to claim 1, wherein a first axial distance (A1) between the second and third plurality of rolling elements is less than or equal to a second axial distance (A2) between the first and the second plurality of rolling elements.

4. The bearing assembly according to claim 1, wherein the outer ring defines a first shoulder adjacent to the first plurality of rolling elements, and a second shoulder adjacent to the second plurality of rolling elements, and the first shoulder and the second shoulder are radially offset from each other.

5. The bearing assembly according to claim 4, wherein a radial offset (R1) between the first shoulder and the second shoulder is at least 4 mm.

6. The bearing assembly according to claim 1, wherein the outer ring defines a first outer raceway for the first plurality of rolling elements and a second outer raceway for the second plurality of rolling elements, and an axial offset (A3) between the first outer raceway and the second outer raceway is at least 4 mm.

7. The bearing assembly according to claim 1, further comprising a cage for supporting the second plurality of rolling elements, and a cage for supporting the third plurality of rolling elements, and distance (A4) between the cage for supporting the second plurality of rolling elements and the cage for supporting the third plurality of rolling elements is less than 0.5 mm.

8. The bearing assembly according to claim 1, wherein an inner raceway for the second plurality of rolling elements terminates radially inward from an inner raceway for the third plurality of rolling elements.

9. The bearing assembly according to claim 1, wherein the outer ring defines a shoulder between an outer raceway for the second plurality of rolling elements and an outer raceway for the third plurality of rolling elements, and the shoulder is arranged radially outward from the outer raceway for the second plurality of rolling elements.

10. The bearing assembly according to claim 1, wherein an outer diameter (OD1) of the outer ring on a first end of the outer ring supporting the first plurality of rolling elements is equal to an outer diameter (OD2) of the outer ring on a second end of the outer ring supporting the third plurality of rolling elements.

11. The bearing assembly according to claim 1, wherein the first plurality of rolling elements have a larger diameter than a diameter of the second and third plurality of rolling elements.

12. A bearing assembly comprising:
a first inner ring and a second inner ring;
an outer ring; and
a first plurality of rolling elements arranged to be supported between the first inner ring and the outer ring;
a second plurality of rolling elements arranged to be supported between the second inner ring and the outer ring; and
a third plurality of rolling elements arranged to be supported between the second inner ring and the outer ring, wherein the second plurality of rolling elements is arranged axially between the first and third plurality of rolling elements,
wherein a first axial distance (A1) between the second and third plurality of rolling elements is less than or equal to a second axial distance (A2) between the first and the second plurality of rolling elements.

13. The bearing assembly according to claim 12, wherein a first contact angle (θ1) is defined between the first plurality of rolling elements and the first inner ring and the outer ring, a second contact angle (θ2) is defined between the second plurality of rolling elements and the second inner ring and the outer ring, and a third contact angle (θ3) is defined between the third plurality of rolling elements and the second inner ring and the outer ring, and the second contact angle (θ2) is less than the first or third contact angles.

14. The bearing assembly according to claim 13, wherein the second contact angle (θ2) is 20 degrees-40 degrees.

15. The bearing assembly according to claim 12, wherein the outer ring defines a first shoulder adjacent to the first plurality of rolling elements, and a second shoulder adjacent to the second plurality of rolling elements, and the first shoulder and the second shoulder are radially offset from each other.

16. The bearing assembly according to claim 15, wherein a radial offset (R1) between the first shoulder and the second shoulder is at least 4 mm.

17. The bearing assembly according to claim 12, wherein the outer ring defines a first outer raceway for the first plurality of rolling elements and a second outer raceway for the second plurality of rolling elements, and an axial offset (A3) between the first outer raceway and the second outer raceway is at least 4 mm.

18. The bearing assembly according to claim 12, further comprising a cage for supporting the second plurality of rolling elements, and a cage for supporting the third plurality of rolling elements, and distance (A4) between the cage for supporting the second plurality of rolling elements and the cage for supporting the third plurality of rolling elements is less than 0.5 mm.

19. The bearing assembly according to claim 12, wherein an inner raceway for the second plurality of rolling elements terminates radially inward from an inner raceway for the third plurality of rolling elements.

20. The bearing assembly according to claim 12, wherein the outer ring defines a shoulder between an outer raceway for the second plurality of rolling elements and an outer raceway for the third plurality of rolling elements, and the shoulder is arranged radially outward from the outer raceway for the second plurality of rolling elements.
